(19) United States
(12) Patent Application Publication
(10) Pub. No.: US 2007/0288532 A1
(43) Pub. Date: Dec. 13, 2007

(54) Method of updating an executable file for a redundant system with old and new files assured

(75) Inventors: Yuusuke Yamazaki, Saitama (JP); Tomotake Koike, Chiba (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/727,885

(22) Filed: Mar. 28, 2007

(30) Foreign Application Priority Data
Mar. 28, 2006 (JP) 2006-088608

(51) Int. Cl. G06F 17/30

(52) U.S. Cl. 707/203; 707/E17.005

(57) ABSTRACT

During an active system providing a service by an old file, a standby system executes the old file and a new file in parallel. Responsively to data transition in the synchronous target memory area of the active system, in parallel to event-driven data synchronization between the old memory areas of both systems, a format conversion from the old memory area to new one is performed before system switching. This makes the format conversion unnecessary in a restart process after system switching, whereby services by the new file can quickly start. The new file allocates the old and new memory areas to different areas. When the format conversion from the old memory area to the new memory area is performed, the old memory area remains stored. This renders it possible to remedy, when restart fails, memory in the own system and perform rollback from the new file to the old file.

### BACKGROUND OF THE INVENTION

1. Field of the Invention

The present invention relates to a file updating method for a redundant system, and more particularly to such a method that is applicable in the case where, in a system such as a call server required to have high reliability, a file such as an executable program sequence providing a service is updated while continuing to provide the service.

2. Description of the Background Art

In general, a system such as a call server, which is required to have high reliability, adopts a duplicate redundant system, as shown in FIG. 2, having an active server A001 and a standby server S001 in order to maintain reliability.

The active server A001 is equipped with hardware A006 having an interface A007, implemented by a network interface card (NIC), and a hard disk A008, and a general-purpose operating system (OS) for linking software described later. Likewise, the standby server S001 includes hardware S006 having an interface (NIC) S007 and a hard disk S008, and a general-purpose OS system for linking software described later. In FIG. 2, as to the general-purpose OS system, only kernels A005 and S005 are illustrated.

The severs A001 and S001 have, in the form of software, service processes A002 and S002, restart controllers A003 and S003, system configuration managers A004 and S004, and so forth. Shared memories A009 and S009 are hardware comprising a semiconductor memory device such as random-access memory (RAM). However, since Shared memories are utilized by the software described above, they are shown in the same hierarchy as the software.

The system configuration managers A004 and S004 are used for performing the state management and fault supervision of the redundant configuration. The restart controllers A003 and S300 are used for performing management such as start-up control and supervision of the service processes A002 and S002. The service processes A002 and S002 are used for holding memory areas A010 and S010 necessary for services such as a call processing service and carrying out the services. The memory areas A010 and S010 necessary for services have to be remedied even when a fault occurs in hardware or software, and accordingly, they are synchronous target memory areas between the active and standby servers A001 and S001.

The expression “synchronous target memory area” used herein is intended to mean a memory area in which the standby server, e.g., S001, can store data equivalent to the data stored in the active server, e.g., A001, so that, even when switching is performed from the active server A001 to the standby server S001, the standby server S001 can provide the same service as the active server A001. Note that a technique for matching call control data with each other and also performing centralized call control data management is disclosed in U.S. patent application publication No. 2001/0048665 A1 by way of example.

The service processes A002 and S002 in FIG. 2 are created based on an executable file stored in the hard disks A008 and S008. For example, software such as an executable file for creating the service processes A002 and S002 may often be revised because of a bug found during the execution. A conventional method of performing the updating of a file in a redundant system such as that shown in FIG. 2 will be described hereinafter with reference to FIG. 3.

Generally, in the redundant system, a new file is first arranged in the standby system, while the active system remains the same. Thereafter, by performing a system switching operation, services are started by the new file. Even when a fault occurs in the new file, a switching back operation of the system can quickly rollback the new file to the old one. In such a redundant system, the file updating operation of the service process is performed as shown in FIG. 3.

Although not illustrated in FIG. 3, while the active server A001 is providing a service by the old service process A002, for example, the operator updates an executable file developed on the hard disk S008 of the standby server S001 to a new executable file.

In such a condition, for instance, when the operator instructs the active server S001 to perform a system switching operation, the system configuration manager A004 of the active system instructs the system configuration manager S004 of the standby system to perform a system switching operation (P100). This instruction may be defined as a system switching operation for switching to a new file.

In the standby system, after receiving a restart request from the system configuration manager S004 (P101), the restart controller S003 finishes the service process (old service process) S002, and loads an updated new executable file from the hard disk S008 onto a work memory area to create a new service process (P103). Thereafter, the restart controller S003 performs a restart process so that the new service process S002 is applicable (P104 and P105). The word “restart” used herein is intended to mean “starting up the new service process, e.g., S002, so as to be operable”.

As described above, when the standby server S001 is instructed to perform a system switching operation, the active server A001 switches itself to its standby condition immediately or after a predetermined period of time. For that reason, during the time the restart process is being performed in the standby system, services are interrupted. If the process of restarting the new service process S002 ends and the restart controller S003 recognizes the end of the restart process (P106), then a restart completion notification signal is sent to the system configuration manager S004 (P107). In this manner, the server S001 that has so far been a standby system begins to operate as an active system which corresponds to the new service process.

In such a state, the server A001 after switched to a standby system has the old service process A002, while the server S001 after switched to an active system has the new service process S002. Thus, both of the servers A001 and S001 are now in an asynchronous state.

After receiving a switching completion notification signal from the server S001 after switched to an active system, the server A001 after switched to a standby system responds to a notification of the completed switching of the other sever S001 to its active state to perform a switching operation so that it is operative to the new service process (P108 to P115), thereby switching to the state of a standby system that corresponds to the new service process. In this manner, both systems are resynchronized with each other.

In the restart process (P105) after the system switching, it is necessary for the new service process to take over the synchronous target memory area S010 that was used by the old service process. For example, in many cases, structures, such as the definition of classes and instances in an object-oriented language, the relationship between classes, etc., are different between the new and old service processes. In order for the new service process to utilize the synchronous target memory area S010, a structural conversion process such as a form, format or type conversion is necessary because of such differences in structure.

The synchronous target memory area S010 that is used by the service process is divided into segments and managed for each segment, depending upon the type of area used. Since the format conversion process varies from segment to segment, the conversion process has to be executed for each segment.

In the conventional file updating method, after system switching, the new service process is started up, and during the restart process of the new service process, the format conversion process is carried out. Because the format conversion process must be carried out for each segment to be managed of the synchronous target memory area, the format conversion process needs to be called out by the number of segments. In an application where a large-scale system such as a call server system is configured, there are a vast number of segments and therefore the restart process, including the format conversion process, requires a long time. Thus, there is a problem that a service interruption time in updating a file would be longer.

In the standby system, the synchronous target memory area that was used by the old service process is overwritten by the format conversion process. For that reason, when the restart process fails after the format conversion process has been initiated, and the rollback from the new file to the old file is performed, the standby system cannot perform the rollback and therefore the system switching operation must be performed from the standby system to the old active system. Thus, there is a problem that service recovery completion by the old file would take a long time.

### SUMMARY OF THE INVENTION

It is an object of the present invention to provide a file updating method for a redundant system that is capable of performing in a short time the updating of a file such as an executable program sequence providing a service, while continuing to provide the service.

It is another object of the present invention to provide a file updating method for a redundant system that is capable of quickly performing rollback from a new file to an old file even when the rollback becomes necessary during file updating.

In accordance with the present invention, there is provided a first method updating a file for a redundant system including an active server and a standby server, each of which has a first file in which service processing is described, a system configuration manager for managing the state and supervising a fault of a redundant configuration, a restart controller for performing management such as start-up control and supervision of the first file, and a first synchronous target memory area on a shared memory for storing synchronous information comprising equivalent data so as to assure data matching when system switching is performed. In the first method, during file updating in the standby server, in addition to the first synchronous target memory area corresponding to the first file before being updated, the standby server separately assures a second synchronous target memory area which corresponds to a second file after updated. After receiving synchronous information for the first file from the active server, the system configuration manager of the standby server stores the synchronous information in the synchronous memory area, and gives the synchronous information to the second file created. Immediately after given the synchronous information, the created second file performs a structural conversion process on the created second file so as to render the second file adaptive to the second synchronous target memory area.

In the first method of the present invention, during file updating, the system configuration manager of the standby system may store the first file until the file updating is completed. When the rollback from the second file to the first file is necessary before file updating is completed, the system configuration manager of the standby system may restart the stored first file that utilizes the first synchronous target memory area.

In accordance with the present invention, there is provided a second method of updating a file for the redundant system described above, wherein, during file updating in the standby server, before restarting a second file after updated and on the basis of synchronous information of the first file before updated which is stored in the first synchronous target memory area, the system configuration manager of the standby server performs a structural conversion process on the second file so as to render the second file adaptive to the synchronous information.

According to the present invention, the updating of a file such as an executable program providing a service can be performed in a short time. In addition, according to the present invention, even when rollback from the new file, i.e., second file, to the old file, i.e., first file, becomes necessary during file updating, the rollback can be quickly performed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a redundant system in accordance with a preferred embodiment of a redundant system of the present invention in which a standby server is executing a system switching operation for updating a file;

FIG. 2 is a schematic block diagram showing a conventional redundant system;

FIG. 3 shows in the form of sequence chart how a file updating process is performed in the conventional redundant system;

FIG. 4 shows in the form of sequence chart how the file updating method is performed in the redundant system of the preferred embodiment shown in FIG. 1;

FIG. 5 is an explanatory block diagram showing the memory allocation of the old and new service processes in the preferred embodiment;

FIG. 6 shows in the form of sequence chart how the file updating process is performed in the redundant system of the preferred embodiment;

FIG. 7 is a flowchart useful for understanding how synchronous information is processed by the system configuration manager of the standby system of the preferred embodiment;

FIG. 8 is a flowchart useful for understanding how synchronous information is processed by the new service process of the standby system of the preferred embodiment;

FIGS. 9A, 9B, and 9C show in the form of schematic block diagrams how the old and new service processes of the standby system of the preferred embodiment perform memory allocation when the restart process fails;

FIG. 10 is a schematic block diagram showing the processing of old file version authentication in a new file program of the preferred embodiment; and

FIG. 11 is a flowchart useful for understanding the processing of the old file version authentication in the new file program of the preferred embodiment.

### DESCRIPTION OF THE PREFERRED EMBODIMENT

A preferred embodiment of a file updating method for a redundant system according to the present invention will hereinafter be described in detail with reference to the drawings.

The fundamental concepts of the preferred embodiment read as follows. During the time an active system is providing a service by an old file, a standby system executes the old file and a new file in parallel. In addition, the data transition in the synchronous target memory area of the active system causes a format or type conversion process from the old memory area to a new memory area to be performed, before system switching, in parallel to data synchronization driven in response to event between the old memory areas of the active and standby systems. This makes the structural conversion process such as a form, format or type conversion unnecessary in a restart process after system switching, whereby the start of services by the new file can be quickly performed. Furthermore, the new file allocates the old and new memory areas to different areas from each other, and even when the format conversion process from the old memory area to the new memory area is performed, the old memory area remains stored. This renders it possible, when the restart process fails, to remedy memory in the own system and perform the rollback from the new file to the old file.

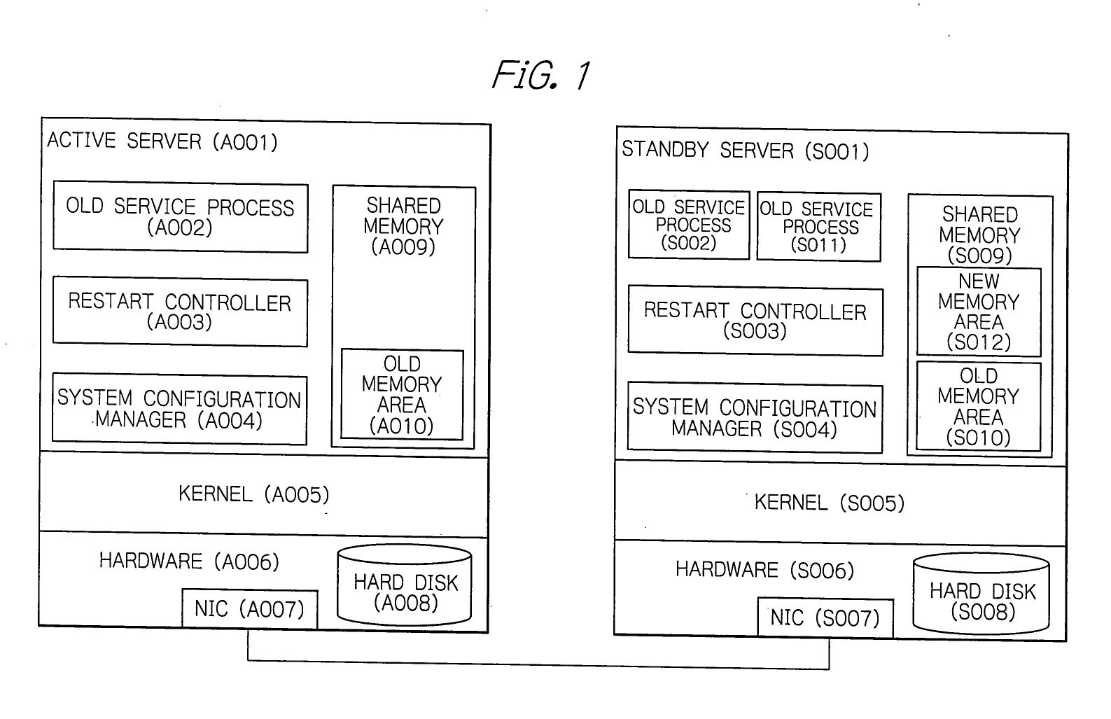

Now, FIG. 1 is a functional block diagram of the state in which a standby server is executing a system switching operation for updating a file in accordance with the redundant system of the preferred embodiment. Throughout the description and accompanying drawings, like parts and components are designated with the same reference numerals.

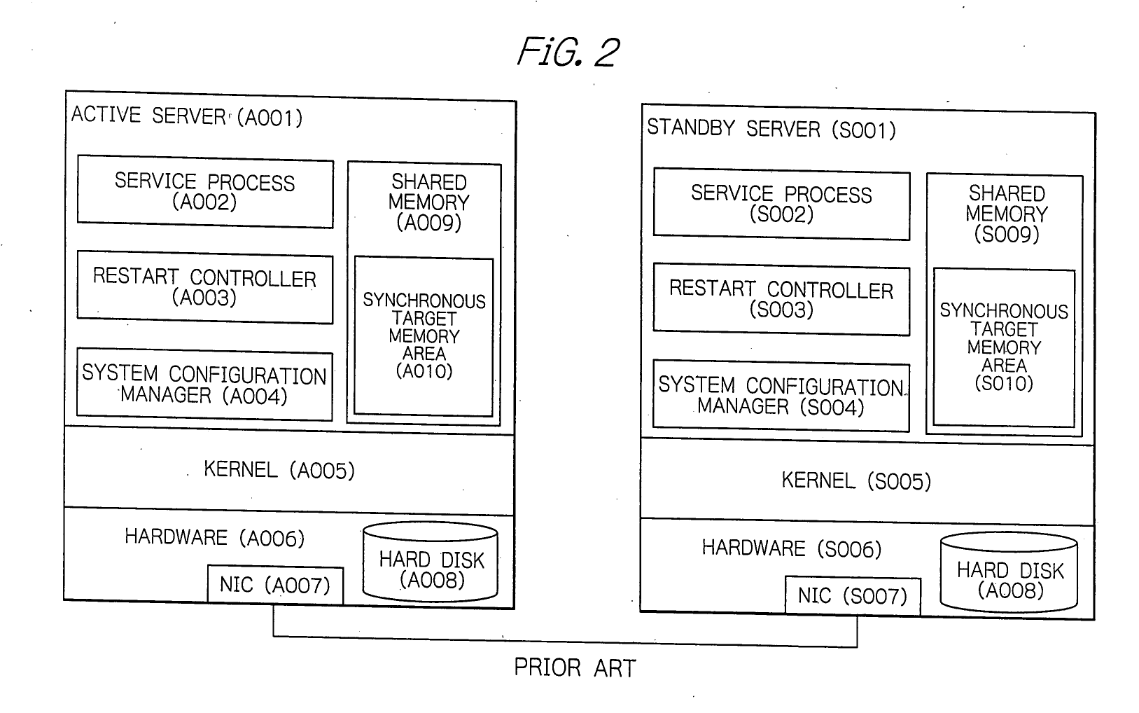

The redundant system of the illustrative embodiment has an active server A001 and a standby server S001 as depicted in FIG. 1. Although not specifically shown, as with other information processing systems, the servers A001 and S001 are configured to include a central processing unit (CPU), memory devices such as read-only memory (ROM), random-access memory (RAM), or the like, a communication section, a hard disk, and so forth. From the viewpoint of the hierarchical functions of the hardware and software in the above-described state, however, the active and standby servers A001 and S001 may be represented in the form as illustrated in FIG. 1. Note that in a normal operating state, the redundant system of the illustrative embodiment can also be expressed like FIG. 2 described above.

In FIG. 1, the active server A001 is equipped with hardware A006 having an interface A007, a hard disk A008, etc., and a general-purpose operating system (OS) for rendering software cooperative, which will be described later. As such, in FIG. 1 only a kernel A005 is illustrated. The standby server S001 similarly includes hardware S006 having an interface S007, a hard disk S008, etc., and a general-purpose OS system for making later-described software cooperative. As such, FIG. 1 shows a kernel S005 only.

The severs A001 and S001 have, in the form of software, service processes A002 and S002, denoted as old service processes A002 and S002 in FIG. 1, restart controllers A003 and S003, system configuration managers A004 and S004, and so on. Shared memories A009 and S009 are hardware comprising a semiconductor memory device such as RAM device. However, since those memories are utilized by the software described above, they are shown in the same hierarchy as the software. The shared memories A009 and S009 are provided with synchronous target memory areas A010 and S010, denoted as old memory areas A010 and S010 in FIG. 1, for storing equivalent data, e.g., instances, of the active and standby systems.

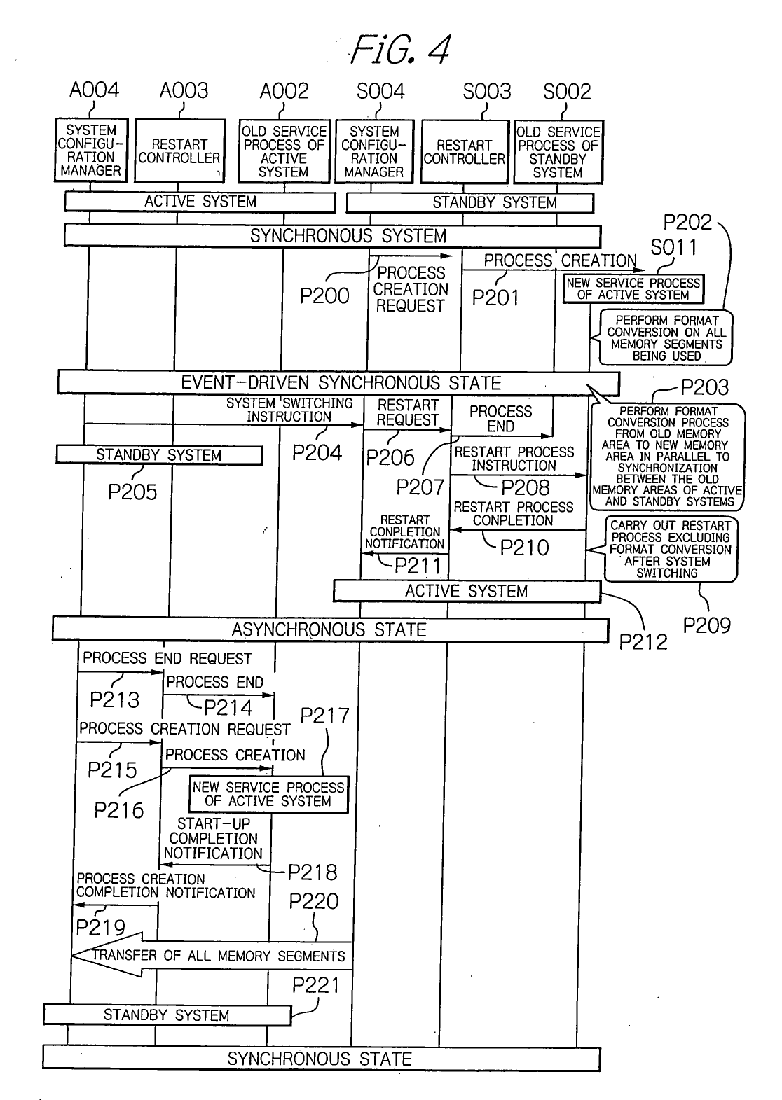

It is to be noted that as to the function of updating a file, restart controllers A003 and S003 and system configuration managers A004 and S004 execute processing which is different from the conventional process. A description will be made later on with reference to FIG. 4.

Until updating a file, a redundant system is established by the above-described constituent elements. However, in the state in which the standby server S001 is executing a system switching operation for updating a file, the standby server S001 has created a service process S011 by file updating, denoted as a new service process S011 in FIG. 1, and a synchronous target memory area S012, which is denoted as a new memory area S012 in the figure and is utilized in a synchronization process by the new service process S011.

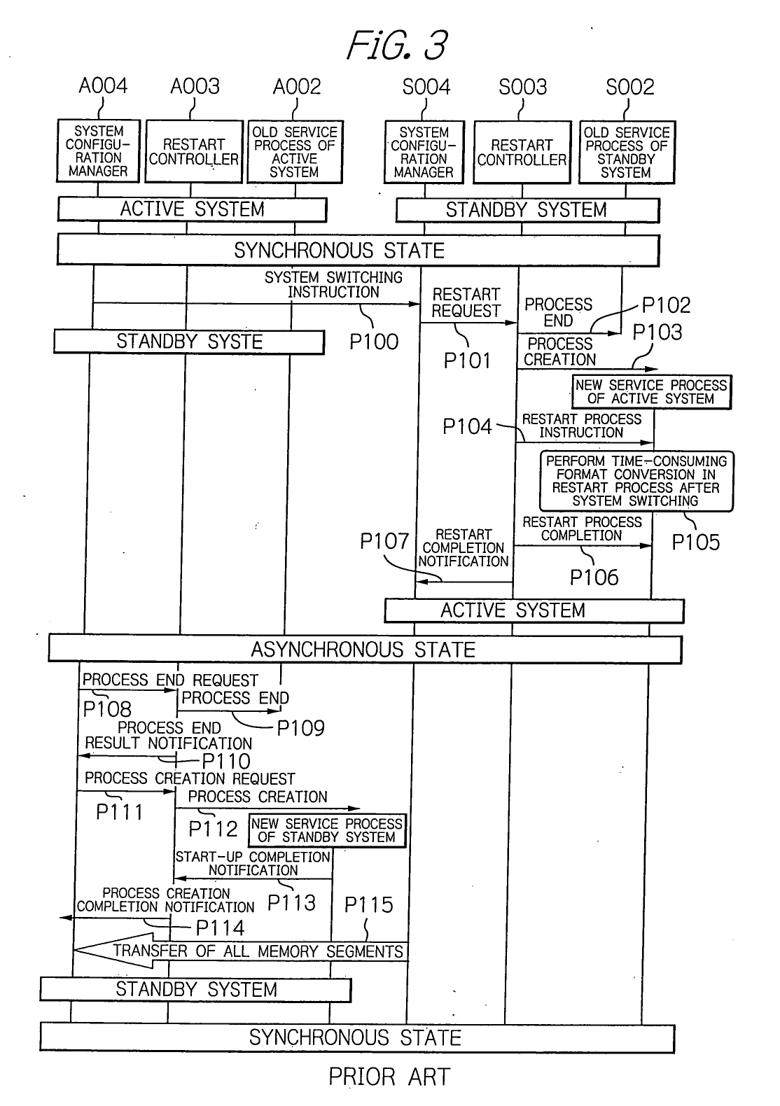

FIG. 4 is a sequence chart for use in understanding the file updating method in the redundant system of the illustrative embodiment and corresponds to FIG. 3 showing the conventional method.

Although omitted from FIG. 4, during the time the active server A001 is providing a service by the old service process A002, for example, the operator updates an executable file developed on the hard disk S008 of the standby server S001 to a new executable file.

In such a state, for instance, if the operator instructs the standby server S001 to take in the new executable file, the system configuration manager S004 of the standby system issues a process creation request to the restart controller S003 (P200). In response to that request, the restart controller S003 creates a new service process S011 as an active system (P201). Note that the system configuration manager S004 of the standby server S001 may automatically perform the above-described step P200 by recognizing that a new executable file is being developed on the hard disk S008.

In the case of the illustrative embodiment, the new service process S011 as an active system comprises a service process main section which performs a service providing process, a post-creation process section which performs an immediate process immediately after being created, and a restart process section which performs a restart process when a system switching instruction is issued for the first time (P202 and P203).

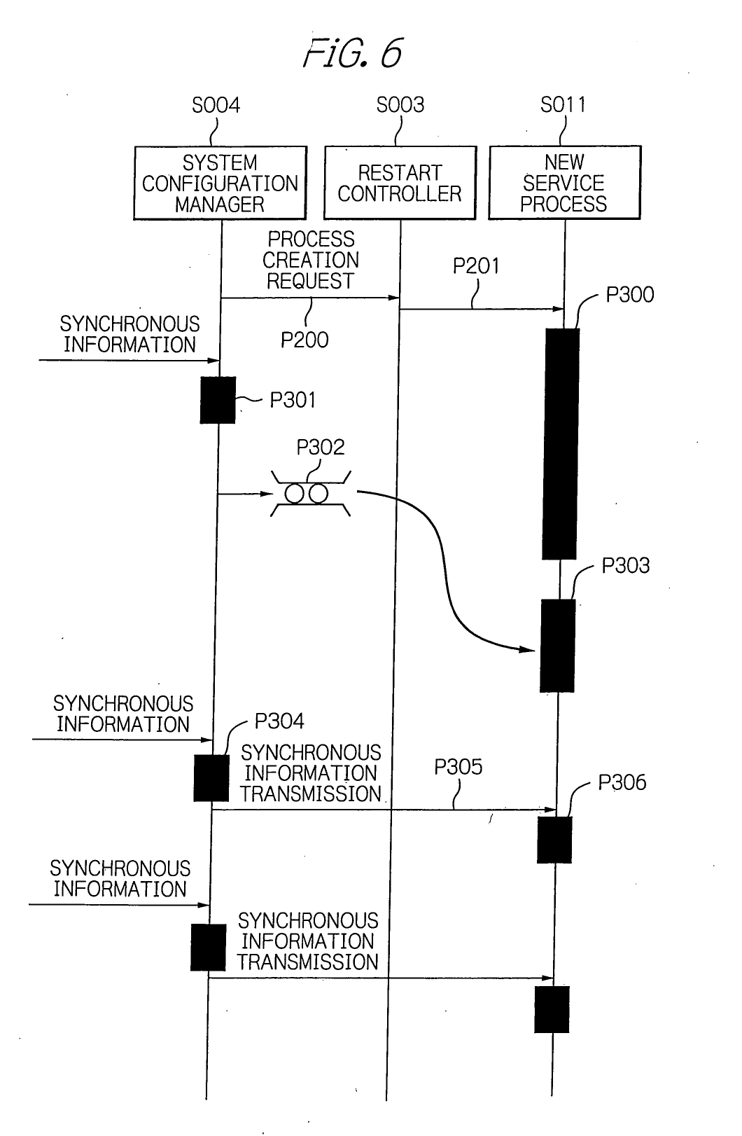

The post-creation process section comprises a first process of creating the new memory area S012 and, as to the old memory area S010 being used, utilizing the new memory area S012 to carry out format conversion; a second process of carrying out the format conversion of synchronous information sent from the active system which is being buffered; and a third process of carrying out the format conversion of synchronous information sent from the active system which is performed after all of the synchronous information being buffered has been processed, as will be described later with reference to FIG. 6. In FIG. 4, the expression “event-driven synchronous state” is intended to mean the state in which the format conversion of synchronous information sent from the active system is carried out, which is performed after all of the synchronous information being buffered has been processed.

As described above, in the state in which the new service process S011 has been created, the new service process S011 is executed in parallel to the old service process S002. In addition to the old memory area S010 that is used by the old service process S002, the new memory area S012 that is used by the new service process S011 is assured on the shared memory S009 of the standby system.

The new service process S011 may function to notify the operator that the standby system is in an event-driven synchronous state, via the system configuration manager S004, for example. The notification may be displayed on a display, or may be the lighting of an indicator such as liquid crystal device (LED), etc.

Alternatively, the new service process S011 may function to notify the active system that the standby system is in an event-driven synchronous state, through the system configuration manager S004, for instance.

For example, if the operator recognizes, by the notification, that the standby system is in an event-driven synchronous state, or recognizes, after a sufficient period of time has elapsed since he or she instructed the standby server S001 to perform a system switching operation, that the standby system is in an event-driven synchronous state, then the operator instructs the active server A001 to perform a system switching operation. At this time, the system configuration manager A004 of the active system instructs the system configuration manager S004 of the standby system to perform the system switching operation (P204). Note that in response to the notification of an event-driven synchronous state, the system configuration manager A004 of the active system may function to instruct the system configuration manager S004 of the standby system to perform the system switching operation.

After instructing the system switching operation, the active server A001 switches to its standby state (P205). At this state, the active server A001 becomes a standby system associated with the old service process A002.

As described above, in the case of the illustrative embodiment, during the time the active server A001 is providing a service by the old file, i.e., old service process A002, the standby server S001 creates the new service process S011 in parallel with the old service process S002 and, as to the memory segments used in the old service process S002, performs a format conversion process so that they are adapted to the new service process S011. Moreover, during the time the active server A001 is providing a service by the old file, i.e., old service process A002, in addition to the synchronization of both systems in the old memory areas A010 and S010 being normally performed, a format conversion process from the old memory area S010 to the new memory area S012 is performed in parallel, for a segment on which a synchronization request was made.

Thus, when the active server A001 instructs the standby server S001 to perform the system switching operation, the format conversion process has already been completed.

In the standby system, if the restart controller S003 receives a restart request from the system configuration manager S004, the restart controller S003 finishes the service process, i.e., old service process, S002 being executed (P207), and instructs the new service process S011 to perform a restart process (P208). The new service process S011 executes the restart process, excluding the format conversion process (P209), and when the restart process is completed, notifies the system configuration manager S004 of that effect through the restart controller S003 (P210 and P211). In response to the notification, the system configuration manager S004 switches the own system, i.e. standby server S001, to an active system that uses the new service process S011 (P212). The instance the system configuration manager S004 switches to an active system, the old service process S002 and old memory area S010 are deleted from the working memory device.

The functional block diagram shown in FIG. 1 as described above depicts the state since the new service process S011 was created (P201) until the time immediately before the standby server S001 switching to its active state in which the new service process S011 is used (P212).

When the standby server S001 becomes an active system that uses the new service process S011, the standby server S011 is no longer synchronized with the active server A001.

If the server A001, after switched from its active state to its standby state, receives from the server S001 of another system notification that it has switched to its active state, the server A001 performs a switching operation so that it can be operative to the new service process S011 (P213 to P221). Note that before the switching operation is initiated, the operator needs to update the executable file developed on the hard disk A008 of the server A001 to a new executable file.

More specifically, in the switching operation in the server A001, the system configuration manager A004 of the server A001 first finishes the old service process A002 through the restart controller A003 (P213 and P214). In addition, the system configuration manager A004 of the server A001 creates a new service process, which corresponds to the new service process S011 of the standby system, through the restart controller A003 (P215, P216 and P217). Furthermore, after receiving notification of the creation completion of the new service process S011 (P218 and P219), the system configuration manager A004 of the server A001 takes and stores in all the values of the data of the synchronous target memory area S012, which is new, from the server S001 being a new active system and stores them (P220), and switches to a standby system which is adapted to the new service process (P221).

In the manner described above, a synchronous state adapted to the updated file, i.e., new service process, is established.

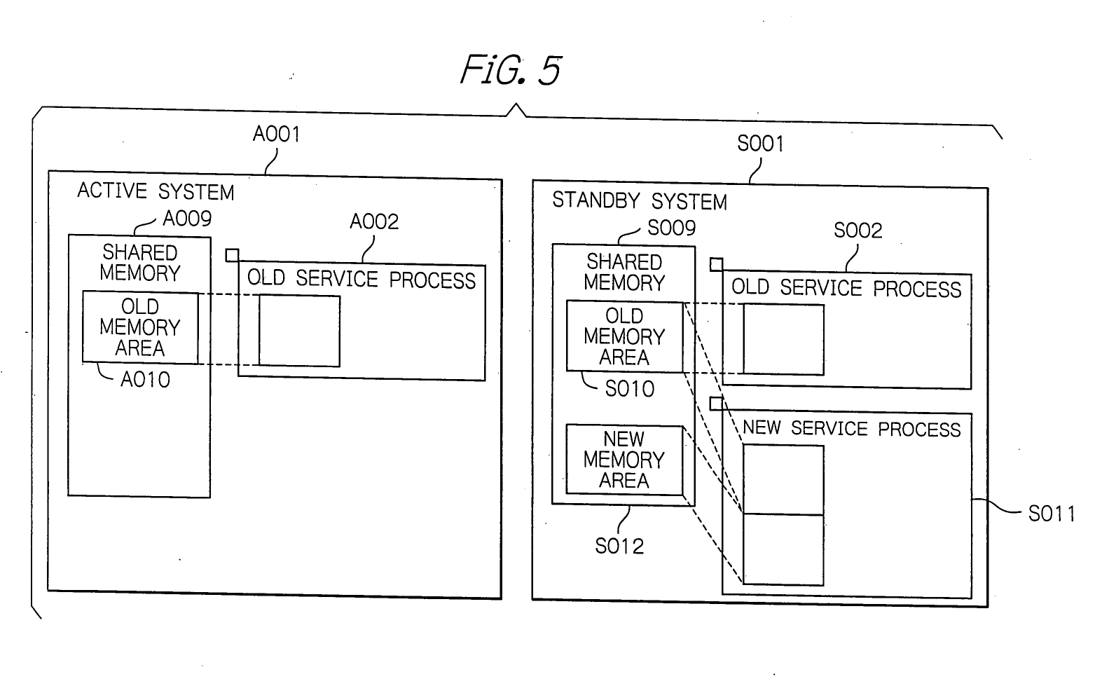

As described above, in the state in which the new service process S011 is created and executed in parallel to the old service process S002, the new and old memory areas S012 and S010 are assured on the shared memory S009 of the standby system. FIG. 5 shows the memory allocation of the old and new service processes S002 and S011.

The old service process A002 of the active system allocates the old memory area A010 on the shared memory A009 to an area on the old service process A002. Similarly, the old service process S002 of the standby system allocates the old memory area S010 on the shared memory S009 to an area on the old service process S002. Moreover, in the standby system, the new service process S011 allocates the old and new memory areas S010 and S012 on the shared memory S009 to different areas on the new service process S011.

The new service process S011 includes the process of format-converting a segment on the memory area S10 into the information of the new memory area S012.

FIG. 6 shows how synchronous information is processed by the system configuration manager S004 and new service process S011. The processing parts shown in FIG. 6 correspond to steps P202 and P203 in FIG. 4, and the synchronous information processing parts in steps P202 and P203 are shown in detail.

In the active system, if data transition occurs in a synchronous target segment, synchronous information is sent form the system configuration manager A004 of the active system, and the system configuration manager S004 of the standby system receives the synchronous information. At this time, synchronous information to be received contains the address and size of the synchronous target segment, and real data to be written. Using these three kinds of information, the synchronous data is written to the memory area S010, which is old, whereby memory synchronization is obtained between the old memory areas A010 and S010.

In the synchronous state, the file updating of the service process is executed. In the standby system, if the new service process S011 is created by the restart controller S003, in the new service process S011 a format conversion process is performed on all memory segments being used for services (P300).

During the format conversion process also, the system configuration manager S004 of the standby system receives synchronous information from the active system and writes that information to the old memory area S010 (P301). However, in the new service process S011, since the format conversion process is being performed on all segments being used, the synchronous information cannot be processed. Therefore, during the format conversion process, the system configuration manager S004 buffers the received synchronous information (P302).

In the new service process S011, if the format conversion process relative to all segments in use ends, the synchronous information buffered by the system configuration manager S004 is reflected on the new memory area S012 (P303). Since the new service process S011 allocates the old memory area S010 and new memory area S012 to different areas, the new service process S011 can receive the address and size of a segment of the old memory area S010 already synchronized and reflect the synchronous information from the old memory area S010 to the corresponding segment on the new memory area S012.

After the processing of all of the synchronous information being buffered has been completed by the new service process S011, if the system configuration manager S004 writes the received synchronous information to the old memory area S010 (P304), the system configuration manager S004 immediately transfers the synchronous information to the new service process S011 without buffering (P305). If the new service process S011 receives this synchronous information, the new service process S011 immediately executes the format conversion process from the old memory area S010 to the new memory area S012, so the format conversion of a target segment to the new memory area S012 is implemented in parallel to the synchronization between the old memory areas A010 and S010 (P306).

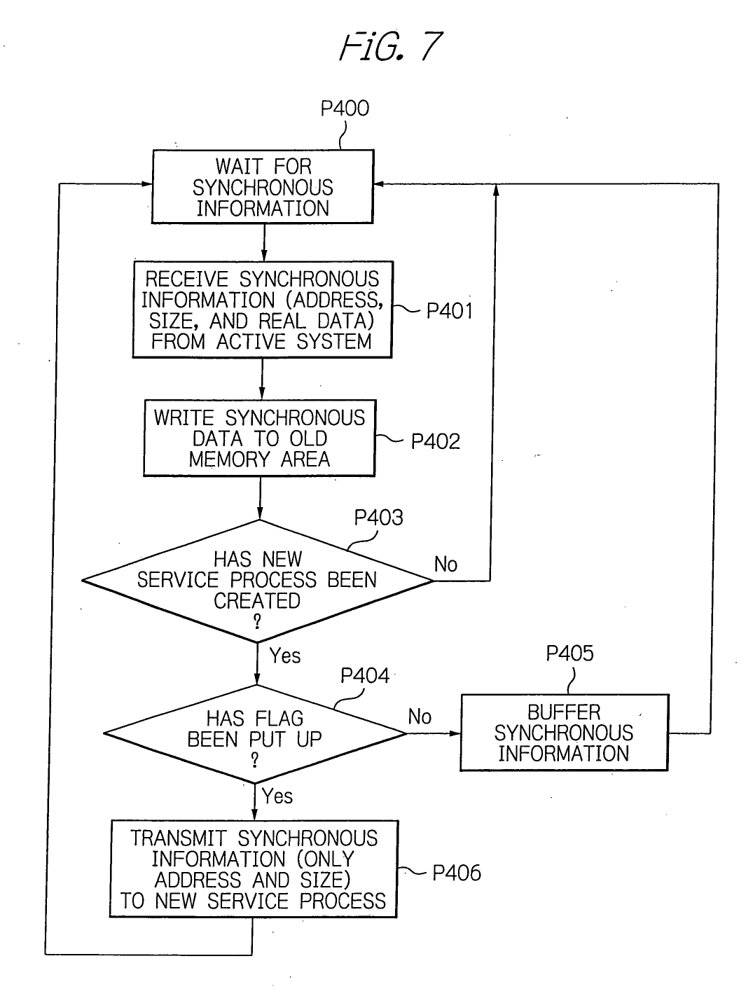

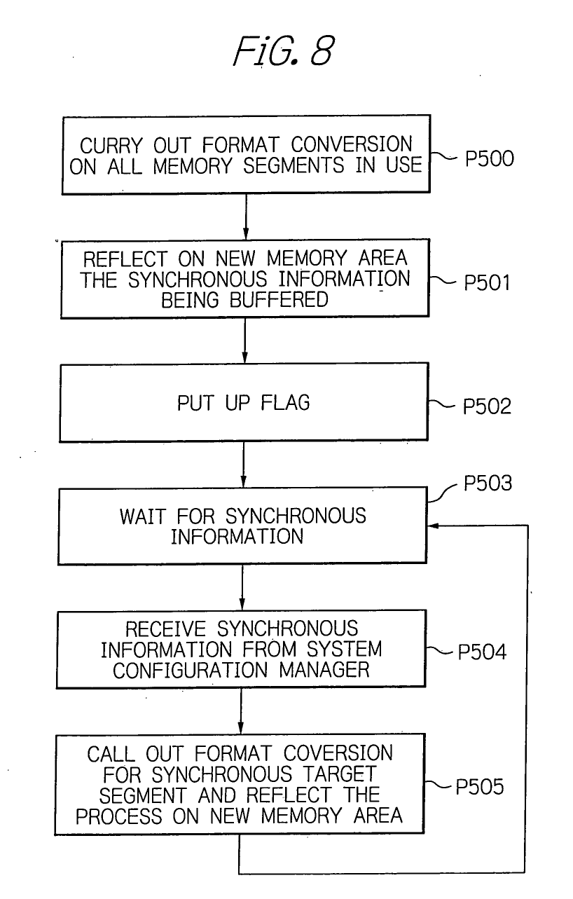

As to the processing of synchronous information described above, FIG. 7 shows how synchronous information is processed by the system configuration manager S004 of the standby system, while FIG. 8 shows how synchronous information is processed by the new service process S011 of the standby system.

The system configuration manager S004 of the standby system is waiting for synchronous information from the active system (P400). After receiving the synchronous information (P401), the system configuration manager S004 writes the synchronous data to the old memory area S010 (P402). Thereafter, the system configuration manager S004 decides whether the new service process S011 has been created, and if it has not been created, returns to the synchronous information waiting state.

If the new service process S011 has been created, the system configuration manager S004 discriminates between two states of a flag indicating whether synchronous information is to be buffered (P404). If the flag indicates that synchronous information is to be buffered, i.e., if it has not been put up, then the system configuration manager S004 buffers the received synchronous information and then returns to the synchronous information waiting state. If the flag indicates that synchronous information is not to be buffered, i.e., if it has been put up, then the system configuration manager S004 transmits the received synchronous information to the new service process S011 (P406) and then returns to the synchronous information waiting state.

The new service process S011 performs the format conversion process on all the memory segments of the old memory area S010 being used (P500). Then, the new service process S011 reflects the synchronous information being buffered on the new memory area S012 (P501). Thereafter, the new service process S011 puts up the above-described flag (P502). Note that the flag is not put up in its initial state so that synchronous information buffered is processed.

Thereafter, the new service process S011 shifts to the synchronous information waiting state (P503). After receiving synchronous information from the system configuration manager S004 (P504), the new service process S011 calls out the format conversion process for a synchronous target segment, reflects the format conversion process on the new memory area S012, and returns to the synchronous information waiting state.

Next, a description will be given with respect to the rollback from the new file to the old file which is performed when the restart process after system switching fails.

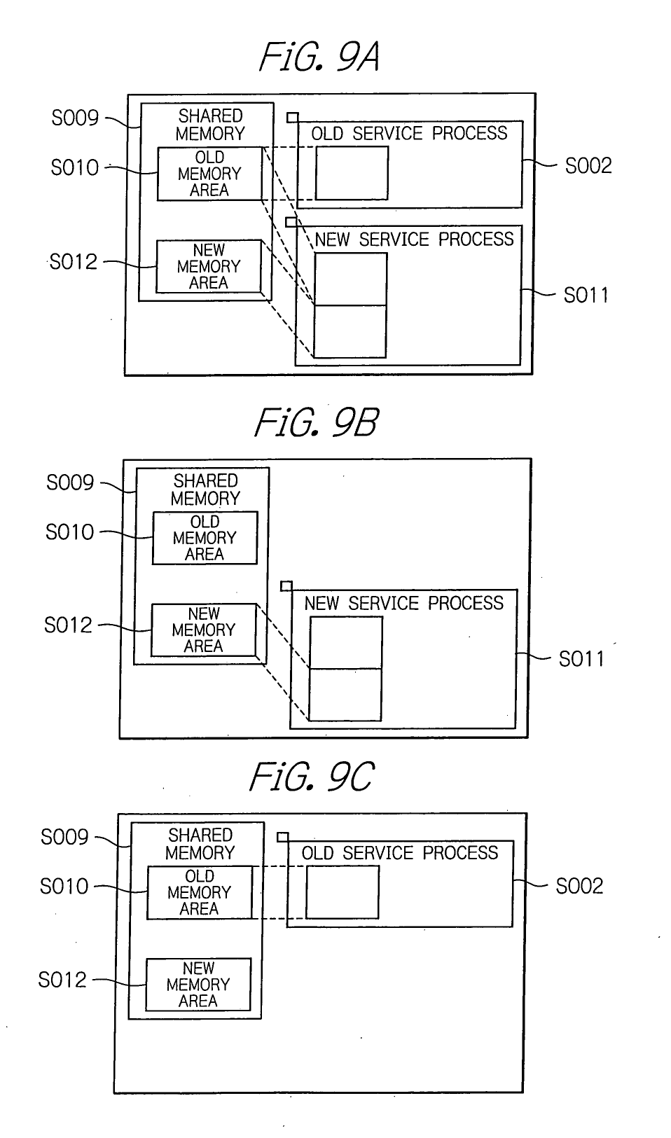

FIGS. 9A, 9B, and 9C show how the old and new service processes of the standby system perform memory allocation when the restart process fails. In the figures, the state from the creation of the new service process S011 to the system switching is the same as FIG. 5. As shown in FIGS. 5 and 9A, the new service process S011 of the standby system maps the old and new memory areas S010 and S012 onto different areas within a virtual space in the new service process S011.

After receiving a system switching instruction from the active system, the standby system instructs the new service process S011 to initiate the restart process. In the restart process, since the new service process S011 begins to provide services, initial settings, such as thread creation, a memory remedy decision, etc., are performed. Since the new service process S011 allocates the new memory area S012 to an area differing from the old memory area S010, as shown in FIG. 9B, the old memory area S010 is stored without being affected, even during the restart process.

When the restart process of the new service process S011 fails, the new service process S011 is finished, and in order to initiate services in the old service process S002, the restart process of the old service process S002 is performed. At this time, in the old service process S002, as shown in FIG. 9C after the rollback, if the old memory area S010 being stored is mapped like the state before the system switching operation shown in FIG. 9A, the memory remedy of the old memory area S010 becomes possible.

In the example of FIGS. 9A, 9B and 9C, while the old service process S002 is finished when the restart process of the new service process S011 is performed, the same applies to the case where the old service process S002 remains stored.

Next, a version management method during the updating of a file will be described in detail. In file updating, when the configuration of a structure in the memory area changes, for example, the format conversion process from the old memory area S010 to the new memory area S012 is implemented into the program, as a service program, of the new file. On the other hand, when all the versions of the old files are shifted at the file updating, it is necessary to grasp a structural difference in memory between all the versions of the old files and the version of the new file. This makes the implementation of the format conversion process practically impossible.

For that reason, the format conversion process is limited by the old file version information. Specifically, memory transfer from an old file to the new file is performed only from the old file of the version that is a memory convertible object by the new file program. When the version of an old file is a version other than the convertible object in the new file, the old memory is discarded. In addition, even in the case of the updating of a file from a version in which memory transfer can be carried out, it is possible to determine whether the format conversion process is necessary for each memory segment or memory segments not requiring the format conversion process are copied from the old memory area S010 to the new memory area S012.

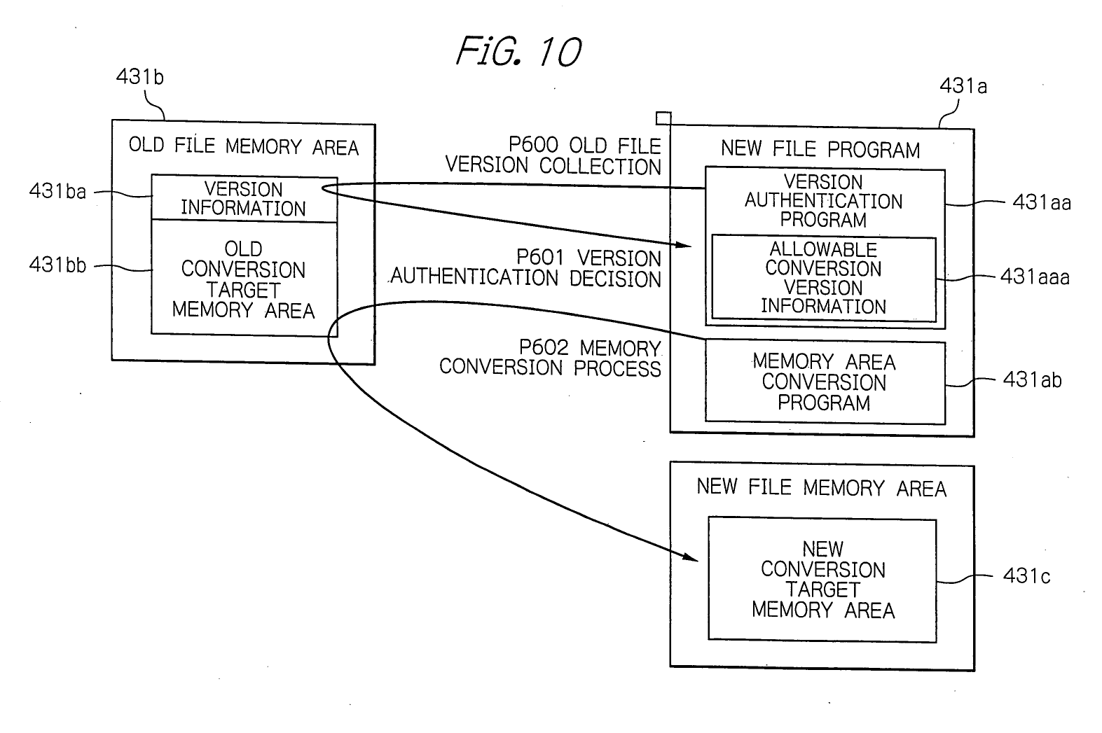

Well, referring to FIG. 10, a new file program (new service process S011) 431a collects the version information of an old file by a version authentication program incorporated therein (P600), and after the determination of version authentication (P601), memory conversion is performed by a memory area converting program 431ab incorporated in the new file program 431a (P602).

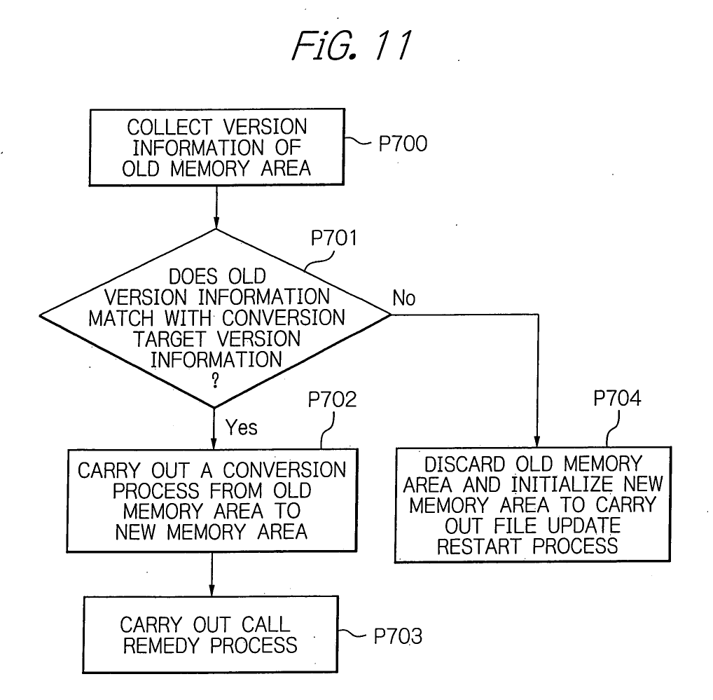

FIG. 11 is a flowchart for use in describing how an old file version authentication process is performed by the new file program 431a. The version information 431ba of an old file is written as information that is unique when the old program file is built. When the program is loaded, the version information 431ba is developed on the shared memory, see FIG. 1, thereby being able to be referenced by the new file program 431a.

The old file version authentication program 431aa of the new file program 431a beforehand, when built, has allowable conversion version information 431aaa held which allows object conversion.

When the new file program 431a is loaded, i.e., when a service program is created, the old file version information 431ba held in the shared memory is collected before performing an old memory conversion process (P700), and by comparing it with the allowable conversion version information 431aaa to check them with each other, authentication is carried out (P701).

By the authentication, it becomes possible to decide whether or not a format conversion process can be performed from the old file memory area 431b by the new file program 431a. The memory area converting program 431ab is called out for each memory segment, and the format conversion process is operated (P702).

In the format conversion process described above, memory segments not requiring format conversion are copied from the old memory area S010 to the new memory area S012. Unlike the format conversion process, the copying or duplicating process is not performed in request units. The remaining segments on which no memory conversion is performed are all copied immediately before the restart process of a new file. In the case where a plurality of segments are collectively copied, they are copied within a kernel at higher speed, compared with the case where the format conversion process is performed on a small-segment basis.

After the execution of the format conversion process, a call remedy process is also executed (P703). The term “format conversion” used in the explanation of FIGS. 4 and 6 is interpreted to cover the possibility of such a call remedy process.

The old file version information 431ba is not contained in the allowable conversion version information 431aaa. Therefore, when version authentication fails, the old memory area S010 is discarded, the new memory area S012 is initialized, and after a restart instruction (see FIG. 4), a file update restart process is carried out (P704).

According to the redundant system and file updating method of the illustrative embodiment, the following advantages are obtainable.

According to the illustrative embodiment, the format conversion from the old memory area to the new memory area is performed in real time in parallel to the synchronization between the old memory areas of the active and standby systems. Accordingly, in the restart process after system switching, the time-consuming format conversion process is unnecessary, so that the time up to the initiation of services by the new service process can be shortened.

In the file updating of the illustrative embodiment, the old and new memory areas, old and new service processes, and the old and new program operations are separated from each other and therefore there is no influence on the synchronization of the old memory areas necessary for the old service processes. When a fault occurs in the active system during a file updating operation, services can be quickly recovered by making use of the old memory area and old service process of the standby system in synchronous with the active system, whereby the file updating operation can be performed while assuring reliability.

According to the illustrative embodiment, even when the service process restart process fails at the time of the file updating, memory can be remedied and rollbacked in the own system itself by mapping the old memory area in which the old service process is stored. Thus, regardless of a state of the other system, safe and quick service recovery is possible in the old file, i.e., old service process.

According to the illustrative embodiment, by taking advantage of file version management such as that described above, in a system environment which differs in file updating process, when file updating is requested from an old file version not recognized by a new file, accurate transfer to file updating without call remedy can be performed.

According to the illustrative embodiment, in the case of a system in which a memory area is divided into a plurality of memory segments, the format conversion and copying processes can be separated for each memory segment. This renders it possible to easily copy memory segments not requiring format conversion from the old memory area, resulting in realization of high-speed processing.

The present invention with a redundant configuration is applied to a system required to have high reliability, such as a system required to continue to provide services even during the updating of an executable file, thereby making the influence of file updating on the system smaller, and maintaining system reliability even during file updating.

The entire disclosure of Japanese patent application No. 2006-88608 filed on Mar. 28, 2006, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A method of updating a file, comprising the steps of:
preparing a redundant system including an active server and a standby server, each of the active and standby servers having a first file in which service processing is described, a system configuration manager for managing a state and supervising a fault of a redundant configuration, a restart controller for performing management such as start-up control and supervision of the first file, and a first synchronous target memory area on a shared memory for storing synchronous information comprising equivalent data so as to assure data matching when system switching is performed;
allowing the standby server to separately assure, during file updating in the standby server, in addition to the first synchronous target memory area corresponding to the first file before updated, a second synchronous target memory area which corresponds to a second file after updated;
storing by the system configuration manager of the standby server, after receiving synchronous information for the first file from the active server, the synchronous information in the synchronous target memory area, and giving the synchronous information to the second file created; and
performing a structural conversion process on the created second file, immediately after given the synchronous information for the first synchronous target memory area, so as to render the second file adaptive to the second synchronous target memory area.

2. The method in accordance with claim 1, wherein
during the file updating, the system configuration manager of the standby system stores the first file until the file updating is completed; and
when rollback from the second file to the first file becomes necessary before the file updating is completed, the system configuration manager of the standby system restarts the stored first file that utilizes the first synchronous target memory area.

3. The method in accordance with claim 1, further comprising the step of determining by the second file for each memory segment whether or not the structural conversion is necessary.

4. The method in accordance with claim 1, further comprising the steps of:
determining a version of the first file by the second file; and
performing a memory remedy for the first synchronous target memory area when the version of the first file is a version which is a memory convertible object of the second file.

5. A method of updating a file, comprising the steps of:
preparing a redundant system including an active server and a standby server, each of the active and standby servers having a first file in which service processing is described, a system configuration manager for managing a state and supervising a fault of a redundant configuration, a restart controller for performing management such as start-up control and supervision of the first file, and a first synchronous target memory area on a shared memory for storing synchronous information comprising equivalent data so as to assure data matching when system switching is performed;
allowing the system configuration manager of the standby server to perform, during file updating in the standby server, before restarting a second file after updated and on a basis of synchronous information of the first file before updated which is stored in the first synchronous target memory area, a structural conversion process on the second file so as to render the second file adaptive to the synchronous information.

6. The method in accordance with claim 5, further comprising the step of determining by the second file for each memory segment whether or not the structural conversion is necessary.

7. The method in accordance with claim 5, further comprising the steps of:
determining a version of the first file by the second file; and
performing a memory remedy for the first synchronous target memory area when the version of the first file is a version which is a memory convertible object of the second file.
